(19) United States
(12) Patent Application Publication
(10) Pub. No.: US 2014/0297170 A1
(43) Pub. Date: Oct. 2, 2014

(54) DRIVING SUPPORT SYSTEM

(71) Applicants: Nippon Soken, Inc., Nishio-city (JP); DENSO CORPORATION, Kariya-city (JP)

(72) Inventors: Taku Sakima, Chiryu-shi (JP); Yoshihisa Ogata, Chiryu-shi (JP)

(73) Assignees: Nippon Soken, Inc., Nishio-city (JP); DENSO CORPORATION, Kariya-city (JP)

(21) Appl. No.: 14/224,443

(22) Filed: Mar. 25, 2014

(30) Foreign Application Priority Data
Mar. 27, 2013 (JP) 2013-066725

(51) Int. Cl. G08G 1/16

(52) U.S. Cl. CPC G08G 1/16
USPC 701/301

(57) ABSTRACT

A driving support system detects a position of an object ahead of an own vehicle as well as predicts a course of the own vehicle. Then, a collision probability between the own vehicle and the object is determined based on the predicted course and the position of the object, and performs the driving support for avoiding collision when the collision probability is high. Further, the driving support to system measures a curvature of a target road, and when a change in the curvature is small and an accurate course prediction is possible, a determination sensitivity of the collision probability is set high so that the driving support is easy to start, otherwise the determination sensitivity of the collision probability is set low so that the driving support is difficult to start.

### CROSS-REFERENCE TO RELATED APPLICATION

This application is based on and claims the benefit of priority from earlier Japanese Patent Application No. 2013-66725 filed Mar. 27, 2013, the description of which is incorporated herein by reference.

### TECHNICAL FIELD

The present disclosure relates to a driving support system for avoiding collisions with pedestrians and other vehicles.

### BACKGROUND

Conventionally, a driving support system that detects objects such as pedestrians and other vehicles around an own vehicle using a camera or radar, and provides driving support such as warning about a collision with objects, intervening in a driving operation in order to avoid the collision, etc. are known.

As an example of such a system, an image recognition apparatus disclosed in Japanese Patent Application

Laid-Open Publication No. 2009-9209 predicts a positional relationship between an own vehicle and an object based on a yaw rate, vehicle speed, etc., and further predicts the approximate position of the object in the future in a captured image by a camera based on the positional relationship.

Then, while reducing processing load during recognition of the object, a warning for avoiding collision is provided by performing image recognition with respect to the display area, and highlighting or the like to the object.

In the driving support system described above, the driving support starts when the positional relationship or the like between the own vehicle and the object meets certain conditions.

However, for example, there is a case where objects by the road or off the road such as guardrails, etc. are positioned ahead of the own vehicle under road conditions where the own vehicle wobbles relative to a traffic lane, or curvatures of entrance and exit, etc. of a curve change.

In such a case, it may be determined mistakenly that a probability that the own vehicle colliding with the objects is high, thus the driving support activates unintentionally.

In order to avoid such an unintended activation, a threshold at a start condition of the driving support has been adjusted so that the driving support is less likely to be started in the driving support system described above.

However, there is sometimes a problem that the start of the driving support will be delayed even though the risk of incorrect collision detection (i.e., a false positive) is low, such as on a straight road.

### SUMMARY

An embodiment provides a driving support system that can begin at a more appropriate timing while preventing an unintended activation of the driving support system.

In a driving support system according to a first aspect, the driving support system includes a detecting unit for detecting objects around an own vehicle, a determining unit for determining whether a probability that the own vehicle collides with one or more objects is equal to or more than a predetermined level or not, a starting unit for starting a driving support for avoiding collision when an affirmative determination is made by the determining unit, a measuring unit for measuring a curvature of a target road on which the own vehicle is expected to travel, and an adjusting unit for adjusting a sensitivity of a determination regarding the probability based on the curvature of the target road measured by the measuring unit.

According to this configuration, when the curvature of the target road is small (or when the own vehicle travels on a straight road, etc.), for example, the determination sensitivity of the collision probability with the object is set high so that the it is easy to confirm that the probability has reached the predetermined level.

Thereby, the driving support can easily be started, and delay in starting the driving support can be prevented.

On the other hand, when the curvature of the target road is high (or when the own vehicle travels on a curve, etc.), for example, the determination sensitivity is set low so that the probability becomes difficult to be determined to have reached the predetermined level.

Thereby, the driving support becomes difficult to start, and even when the objects by the road or off the road such as the guardrails, etc. are detected as the featured object, the unintended activation of the driving support caused by the mistaken determination that the probability of the own vehicle colliding with such objects is high can be prevented.

Therefore, while preventing the unintended activation of the driving support, starting the driving support at a more appropriate time becomes possible.

In the driving support system according to a second aspect, the determining unit determines whether the probability is equal to or more than the predetermined level or not by considering a course of the own vehicle predicted from a condition of the own vehicle, and the adjusting unit adjusts the sensitivity based on a degree of change in the curvature in the target road measured by the measuring unit.

In the driving support system according to a third aspect, the adjusting unit increases the sensitivity when the degree of change in the curvature is less than the predetermined level.

In the driving support system according to a fourth aspect, the adjusting unit reduces the sensitivity when the degree of change in the curvature is equal to or more than the predetermined level.

### BRIEF DESCRIPTION OF THE DRAWINGS

In the accompanying drawings:

FIG. 1 shows a block diagram showing a configuration of a driving support system;

FIG. 2 shows an explanatory diagram for adjusting a sensitivity regarding a determination (determination sensitivity) of a collision probability between an own vehicle and an object;

FIG. 3 shows a flow chart for determination sensitivity adjusting process; and

FIG. 4 shows a flowchart for driving support starting process.

### DETAILED DESCRIPTION OF THE PREFERRED EMBODIMENTS

With reference to the accompanying drawings, hereinafter will be described embodiments of the present disclosure.

Note that embodiments of the present disclosure is not limited to embodiments described below, but may take various forms as long as they fall within a technical scope of the present disclosure.

### [Explanation of Configuration]

A driving support system 10 of the present embodiment determines a probability that an own vehicle will collide with an object such as a pedestrian or another vehicle, and when the collision probability is equal to or more than a certain level, a driving support such as warnings or stopping of the own vehicle is provided.

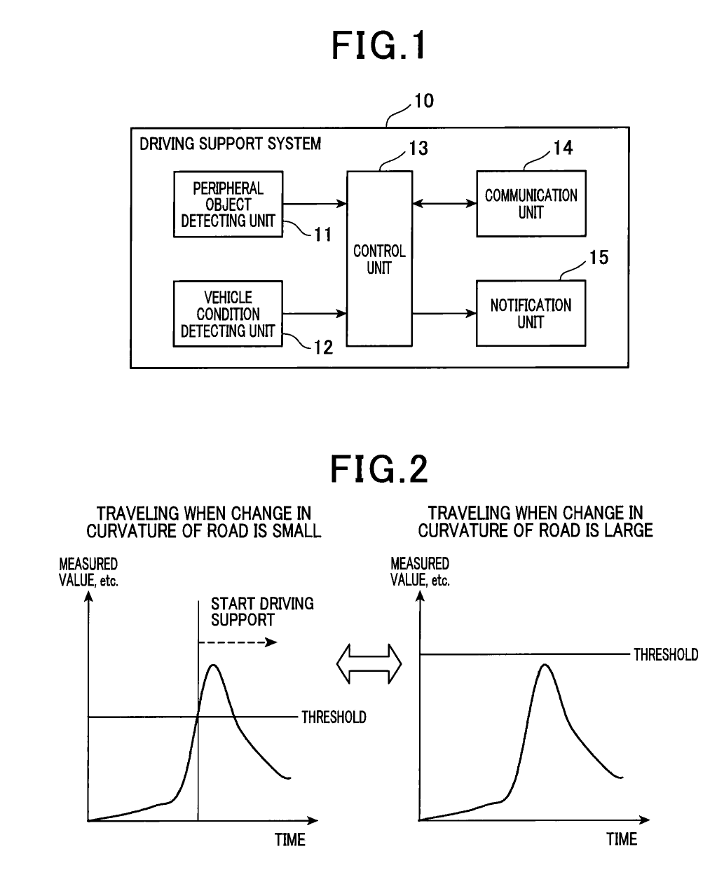

The driving support system 10 is composed of a peripheral object detecting unit 11, a vehicle condition detecting unit 12, a control unit 13, a communication unit 14, a notification unit 15, and the like (refer to FIG. 1).

The peripheral object detecting unit 11 is configured such as a camera for photographing a front of the own vehicle, or as a radar for transmitting radio waves of microwave or millimeter wave to the front of the own vehicle and receives echoes.

The peripheral object detecting unit 11 is a section that detects positions, sizes, shapes and the like of objects existing in front of or around the own vehicle.

The peripheral object detecting unit 11 may be configured by both the camera and the radar, or may be configured by either one of them.

Further, the vehicle condition detecting unit 12 is composed of a yaw rate sensor, a steering angle sensor, a vehicle speed sensor, etc., and is a section that detects one or both of a yaw rate and/or a steering angle (hereinafter, described simply as the yaw rate or the like) and vehicle speed of the own vehicle.

A configuration for obtaining the yaw rate, the steering angle or the vehicle speed detected by another ECU (electronic control unit) through an in-vehicle LAN may be adopted.

The control unit 13 is composed of a CPU, ROM, RAM, I/O, etc., and is a section for overall control of the driving support system 10.

The communication unit 14 is a section that communicates with the other ECU through the in-vehicle LAN.

Further, the notification unit 15 is configured as a speaker or a displaying device, and is a section for performing various warnings for the driving support.

### [Explanation of Operations]

(1) Outline

First, an outline of operation of the driving support system 10 of the present embodiment is explained.

The driving support system 10 detects via the peripheral object detecting unit 11 positions, sizes, shapes and the like of objects such as pedestrians, other vehicles, debris, etc. existing in and around the road ahead of the own vehicle (target road, i.e., a road on which the own vehicle is expected to travel) where the own vehicle is predicted to be travelling.

Further, the driving support system 10 is also possible to calculate a moving speed or a moving direction of the object based on a history information such as the positions of the object.

Furthermore, the driving support system 10 periodically measures the yaw rate or the like and the vehicle speed by the vehicle condition detecting unit 12, and predicts a course of the own vehicle based on a result thereof.

Then, the driving support system 10 determines a collision probability between the own vehicle and the objects based on the predicted course and the positions of the objects, and begins the driving support when a collision probability is equal to or more than a certain level.

Here, there is a case where the yaw rate and the like greatly vary instantaneously due to a vibration of a steering wheel or noise when predicting the course based on the yaw rate and the like, and an accuracy of a course prediction decreases if such variations are reflected directly in the prediction of the course.

Therefore, in the driving support system 10, a low-pass filtering is applied for each measurement of the yaw rate or the like, and thereby an influence of sudden changes in the yaw rate or the like is suppressed, thus it becomes possible to predict the course accurately even when the vibration of the steering wheel, etc., occurs.

However, by applying a low-pass filtering, time lag occurs until a change in yaw rate or the like caused by a steering operation to be reflected in the course prediction.

Thus, for example, when running on a curve, since it is not possible to predict the course accurately under a situation where the curvature of the road changes suddenly like the entrance of the curve, a situation where the exact route prediction becomes possible after passing through the entrance and steering becomes stable occurs.

Thus, by applying the low-pass filtering process, it becomes impossible to predict the exact route under certain circumstances, and as a result, the collision probability with the object based on the predicted course cannot be accurately determined, thus the driving support can easily activates unintentionally.

Therefore, conventionally, in order to prevent the unintended activation of the driving support when performing the driving support based on the collision probability of such, a threshold when determining the collision probability, another threshold regarding the start condition of the driving support based on the collision probability, and the like has a tendency to be set in which the driving support is less likely to be started (in other words, conventionally, the sensitivity of the determination (determination sensitivity) on the collision probability has been set low).

Therefore, there is a problem that the start timing of the driving support is delayed even when the own vehicle is traveling on a road where the course prediction can be performed accurately on the basis of the yaw rate or the like such as a straight road where the curvature is constant.

Therefore, the curvature of the target road is measured via the peripheral object detecting unit 11 in the driving support system 10 of the present embodiment.

Then, when the change in curvature of the target road is large, the driving support system 10 is set to a state where the determination sensitivity of the collision probability between the own vehicle and the object is low, thus the driving support becomes difficult to start.

Further, when the change in curvature of the target road is small, the driving support system 10 is set to a state where the determination sensitivity is high, thus the he driving support becomes easy to start (refer to FIG. 2).

The following describes in detail a process of adjusting the determination sensitivity, and a process at the start of the driving support.

(2) Determination Sensitivity Adjustment Process

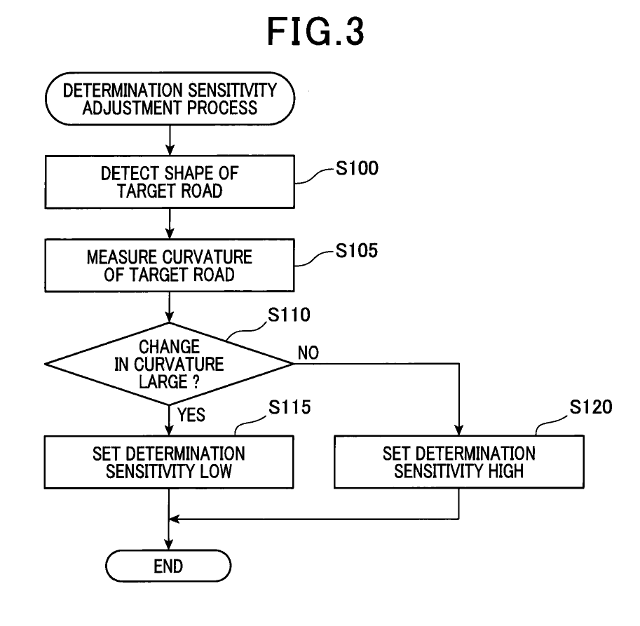

First, the determination sensitivity adjustment process for adjusting the determination sensitivity is described with reference to the flow chart disclosed in FIG. 3.

The present process is executed at periodic timing in the control unit 13 of the driving support system 10.

In a step S100, the control unit 13 defines a road having a predetermined length extending forward starting from the own vehicle as a target road, and detects a shape of the target road by the peripheral object detecting unit 11, then the process proceeds to a step S105.

Specifically, when the peripheral object detecting unit 11 is configured as a camera, the control unit 13 may perform white line recognition or the like, for example, using an image captured by the camera and detect the shape of the target road.

Further, when the peripheral object detecting unit 11 is configured to use radar, the control unit 13 may detect the shape of the target road based on a shape or position of the object detected by the radar.

In the step S105, the control unit 13 sets a plurality of curvature determination points with fixed intervals therebetween from a current position of the own vehicle through an end of the target road, and measures the curvature (or curvature radius) at each curvature determination point, then the process proceeds to a step S110.

In the step S110, the control unit 13 determines whether a degree of the change of curvature at the target road is large or not.

Specifically, the control unit 13 calculates a difference between the maximum and minimum values of the curvature or a standard deviation of each curvature, for example, and when the calculated values exceed a predetermined threshold, the degree of the change of curvature may be determined to be large.

Then, the control unit 13 the process proceeds to S115 when an affirmative determination is obtained (S110: Yes), while the process is proceeded to a step S120 when a negative determination is obtained (S110: No).

In the step 5115, the control unit 13 sets the determination sensitivity to low, then finishes the process.

On the other hand, in the step S120, the control unit 13 sets the determination sensitivity to high, and then finishes the process.

(3) Adjustment of Determination Sensitivity

Here, a specific example of an adjustment of the determination sensitivity is explained.

First, regarding a method of determining the collision probability, it is considered that a predicted collision position or a predicted collision timing between the own vehicle and the object may be estimated based on, for example, a predicted course of the own vehicle, the own vehicle speed, a position of the object, its size, its moving direction, or its moving speed, etc.

Then, a remaining distance to the predicted collision position or a remaining time to the predicted collision timing is calculated, and when the calculated value is equal to or less than the threshold value, it is considered that the collision probability is equal to or more than a certain level and the driving support is started (in a such case, the remaining distance or the remaining time being equal to or less than the threshold becomes the starting condition of the driving support).

Further, a lateral distance between the own vehicle and the object in the predicted collision position is estimated based on, for example, the width of the own vehicle or a position of a side of the object (horizontal position), etc., and when the estimated value is equal to or less than the threshold, it is considered that the collision probability is equal to or more than to a certain level and the driving support is started (in a such case, the estimated value of the distance in the lateral direction being equal to or less than the threshold becomes the starting condition of the driving support).

When in such a case, the driving support becomes easy to start if the threshold value is set large and the determination sensitivity is high, while the driving support becomes difficult to start if the threshold value is set small and the determination sensitivity is low.

Further, for example, when the peripheral object detecting unit 11 is configured to use the radar, a radio wave is irradiated periodically in the driving support system 10, while the position of the object is measured by an echo, and measured results are stored.

Further, the position of the object or the like is continuously measured by irradiation of the radio waves in each period, and when the object is in the same position, or when the position of the object is moving in a certain direction, an existence probability of the object is calculated based on the number of times the position of the object is measured.

The existence probability increases as the number of the positions of the object measured increases, and when the existence probability is equal to or more than the threshold, it is recognized as the object is in existence.

Therefore, if the threshold of the existence probability is reduced, the object becomes easily detected by the peripheral object detecting unit 11, and since the detection sensitivity of the object is increased, the determination sensitivity becomes high.

On the other hand, if the threshold of the existence probability is increased, the object becomes difficult to be detected by the peripheral object detecting unit 11, and since the detection sensitivity of the object is decreased, the determination sensitivity becomes low.

Further, since the collision probability of the object that exists in a lane on which the own vehicle is traveling (own traveling lane) is high, it is considered that the start condition is set so as to start the driving support earlier when such object is detected.

Then, when the peripheral object detecting unit 11 is configured to use the radar, whether the object is in the own traveling lane is determined based on the position of the object measured by irradiation of the radio waves in each period.

That is, an own lane existence probability that is a probability that the object exists in the own traveling lane is calculated based on a measured result of the positions of each period, and when the own lane existence probability is equal to or more than a threshold, an object is recognized as being in the own traveling lane.

Therefore, if the threshold of the own lane existence probability is reduced, the object is easy to determine as being existed in the own traveling lane, and as a result, since the driving support is to be started early, the determination sensitivity becomes high.

On the other hand, if the threshold of the own lane existence probability is increased, it is more difficult for the object to be determined as existing in the own traveling lane, and as a result, since the driving support is started late compared with a situation where the object exists in the own traveling lane, the determination sensitivity becomes low.

(4) Driving Support Starting Process

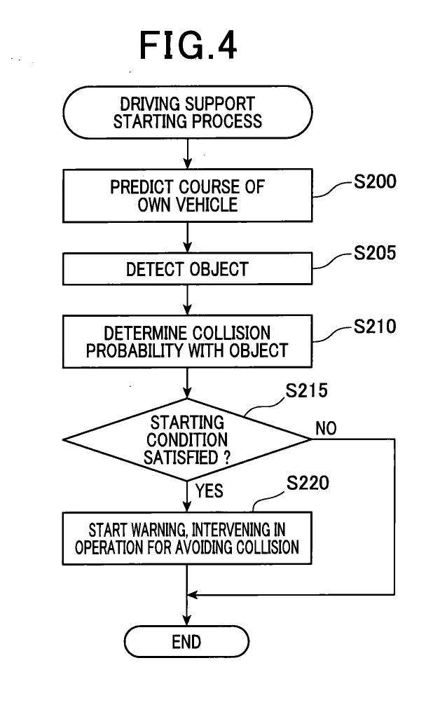

Next, the driving support starting process for starting the driving support according to the collision probability with the object will be described with reference to a flowchart disclosed in FIG. 4.

The present process is executed at periodic timing by the control unit 13 of the driving support system 10.

In a step S200, the control unit 13 measure the yaw rate and the own vehicle speed, etc. in the vehicle condition detecting unit 12, and performs low-pass filtering process on the measured result of the yaw rate and the like.

Then, the control unit 13 predicts the course of the own vehicle based on the measured result from the yaw rate and the speed measurements, where the low-pass filtering is applied, and the process proceeds to a step S205.

In the step S205, the control unit 13 detects the front of the own vehicle or the position, the size, the shape, or the like of the object by the peripheral object detecting unit 11, and the process proceeds to a step S210.

In the step S210, the control unit 13 determines the collision probability with the object based on the predicted course of the own vehicle, the position, the size, and the like of the object, then in a subsequent step S215, it is determined whether the collision probability with the object is equal to or more than a certain level so that the starting condition of the driving support is satisfied.

Specifically, as described above, the remaining distance to the predicted collision position or the remaining time to the predicted collision timing is calculated, and the calculated values being equal to or less than the threshold may be used as the starting condition of the driving support.

Further, the lateral distance between the own vehicle and the object in the predicted collision position is estimated, and the estimated value, if it is less than or equal to the threshold, may be uses as the starting condition of the driving support.

Then, the control unit 13 the process proceeds to a step S220 when the start condition is satisfied (S215: Yes), while the process is finished when the start condition is not satisfied (S215: No).

In the step S220, the control unit 13 performs the process for the driving support, and then finishes the process.

Specifically, for example, the control unit 13 may emit a warning sound or display a warning message that indicates the collision probability is high through the notification unit 15.

Of course, the control unit 13 may communicate with another ECU via the communication unit 14 and output the warning sound or the warning message by the ECU.

Further, the control unit 13 may communicate with the other ECU via the communication unit 14 and actuate brakes to stop the own vehicle, or may perform a steering assist in order to alter the course of the own vehicle so as to avoid collision with the object.

### [Effect]

In the driving support system 10 of the present embodiment, the determination sensitivity is set to a high state when the accurate course prediction based on the yaw rate or the like is possible such as in the case of traveling the straight road or the curve having the constant curvature.

Therefore, the driving support can be easily started, and can prevent the start timing of driving support from being delayed.

On the other hand, the determination sensitivity is set to a low state when accurate course prediction based on the yaw rate or the like is impossible and the precise determination of the collision probability is difficult as in the case of traveling the entrance or the like of a curve where the curvature of the road varies.

Therefore, the driving support can be made difficult to start, and this can prevent the unintended activation of the driving support.

Accordingly, it is possible to prevent the unintended activation of the driving support, while the driving support can be started at a more appropriate time.

### [Other Embodiments]

(1) Although the control unit 13 adjusts the sensitivity of the collision probability with the degree of change in the curvature in the target road in the determination sensitivity adjustment process in the present embodiment, it is also possible to adjust the sensitivity of the collision probability with the value itself of the curvature of the target road.

That is, the control unit 13 measures the maximum value of the curvature of the target road, for example, and when the maximum value exceeds the threshold value, the determination sensitivity of the collision probability may be set to the low state, while when the maximum value does not exceed the threshold value, the determination sensitivity of the collision probability may be set to the high state.

Instead of the maximum value of the curvature, an average value or the like of the curvature of the target road, for example, may be used.

When the own vehicle is traveling on a sharp curve, and when the objects by the road or off the road such as guardrails, etc., are positioned in front of the own vehicle, it may be determined mistakenly that the probability of colliding to these object thereof is high, and there is a probability that the driving support may activate unintentionally.

In contrast, according to the above configuration, the determination sensitivity of the collision probability is set low when running on a curve, and since the driving support is not easily started, it is possible to prevent the unintended activation of the driving support.

Further, when the own vehicle is traveling on a straight road or a gentle curve, and when a probability that the determination is made mistakenly is low, since the determination sensitivity of the collision becomes high, the driving support is more likely to be performed timely.

(2) The control unit 13 measures the curvature of the target road by the peripheral object detecting unit 11 that is configured as the camera or the radar in the determination sensitivity adjustment process in the present embodiment.

However, it is possible to calculate the curvature by obtaining the shape of the target road from the map data provided in the navigation device or the like, for example.

It is possible to obtain the same effect even in such a case.

(3) Although the control unit 13 determines the collision probability based on the predicted course of the own vehicle in the driving support starting process of the present embodiment, the collision probability may be determining without considering the predicted course.

Specifically, for example, the control unit 13 may determine the collision probability based on whether the distance between the own vehicle and the object becomes less than a certain threshold, whether an object approaching to the own vehicle at a speed greater than or equal to the predetermined threshold exists in the own vehicle surroundings, or the like.

When determining the collision probability in this manner, the determination accuracy of the collision probability will not be lowered by the influence of the change in the curvature of the target road.

Therefore, as mentioned in (1), it is also possible to adjust the sensitivity of the collision probability with the value itself of the curvature of the target road.

It is possible to obtain the same effect even in such a case.

(4) In the driving support starting process of the present embodiment may be configured to provide a plurality of types of driving supports and perform different types of driving support depending on how high the collision probability is.

Specifically, two types of driving supports may be provided for warnings and operation interventions, respectively.

The starting condition may be set so that the driving support starts performing the warnings when the collision probability is relatively low, and the starting condition may be set so that the driving support starts performing the operation interventions when the collision probability is relatively high.

Further, when performing the driving support in such a way, in the determination sensitivity adjustment process, the determination sensitivity may be adjusted by adjusting the threshold regarding the starting condition of each driving support, or the determination sensitivity may be adjusted by adjusting the threshold regarding the starting condition of any one of the driving supports.

It is possible to obtain the same effect even in such a case.

### [Correspondence Between the Claims]

Correspondences between terms used in the description of the above embodiments and terms used in the claims are shown hereafter.

The step S105 of the determination sensitivity adjustment process in the present embodiment corresponds to a measuring unit, and the steps S110, S115, and S120 correspond to an adjusting unit.

In addition, the step S205 of the driving support starting process corresponds to a detecting unit, the steps S210 and S215 correspond to a determining unit, and the step S220 corresponds to a starting unit.

What is claimed is:

1. A driving support system comprising:
a detecting unit for detecting objects around an own vehicle;
a determining unit for determining whether a probability that the own vehicle collides with one or more objects is equal to or more than a predetermined level or not;
a starting unit for starting a driving support for avoiding collision when an affirmative determination is made by the determining unit;
a measuring unit for measuring a curvature of a target road in which the own vehicle is predicted to travel; and
an adjusting unit for adjusting a sensitivity of a determination regarding the probability based on the curvature of the target road measured by the measuring unit.

2. The driving support system according to claim 1, wherein,
the determining unit determines whether the probability is equal to or more than the predetermined level or not by considering a course of the own vehicle predicted from a condition of the own vehicle; and
the adjusting unit adjusts the sensitivity based on a degree of change in the curvature in the target road measured by the measuring unit.

3. The driving support system according to claim 2, wherein,
the adjusting unit increases the sensitivity when the degree of change in the curvature is less than the predetermined level.

4. The driving support system according to claim 2, wherein,
the adjusting unit reduces the sensitivity when the degree of change in the curvature is equal to or more than the predetermined level.

5. The driving support system according to claim 3, wherein,
the adjusting unit reduces the sensitivity when the degree of change in the curvature is equal to or more than the predetermined level.
